(19) United States
(12) Patent Application Publication
(10) Pub. No.: US 2026/0076858 A1
(43) Pub. Date: Mar. 19, 2026

(54) SYSTEM AND METHOD TO MOVE INTO AND OUT FROM A SYSTEM TO ASSIST WALKING

(71) Applicant: ABLE HUMAN MOTION, S.L., BARCELONA (ES)

(72) Inventors: Katlin Jean KREAMER-TONIN, Barcelona (ES); Joan LOBO PRAT, Barcelona (ES); Vicent PÉREZ GREGORI, Barcelona (ES); Alex GARCIA FARRENY, Barcelona (ES)

(21) Appl. No.: 19/108,412

(22) PCT Filed: Sep. 8, 2023
(86) PCT No.: PCT/EP2023/074742

§ 371 Date: Mar. 3, 2025

Related U.S. Application Data
(60) Provisional application No. 63/404,658, filed on Sep. 8, 2022.

(51) Int. Cl. A61H 3/00; A61H 1/02

(52) U.S. Cl. CPC A61H 3/00; A61H 1/0262; A61H 2003/007; A61H 2201/164; A61H 2201/165; A61H 2201/5064; A61H 2203/0431

(57) ABSTRACT

A system to assist walking includes two orthoses. The two orthoses include a first articulation for the hip articulation of each of the user's leg and a thigh segment connected to the first articulation, where at least one orthosis further comprises a first fixing mechanism configured to fix the first articulation. The at least one orthosis can be set into a user transfer position. In the user transfer position, the first fixing mechanism can fix the thigh segment at an angle of at least 60° with respect to the thigh segment of the opposite orthosis.

### FIELD

The present invention relates to the field of wearable robotic systems. Particularly, the present invention relates to a system to assist walking allowing the user to move into and out from it by comprising at least one orthosis which can be set into a position wherein a first articulation designed for the hip articulation of the user's leg is fixed in a position that facilitates such movement, and to a method thereof.

### BACKGROUND

Patients who have motor neurological impairments (such as spinal cord injury, stroke, multiple sclerosis, traumatic brain injury, etc) have limited or no motor function in their lower limbs and trunk. They have disabilities related to mobility and walking. As part of their physical therapy or rehabilitation program, they may use a robotic exoskeleton for gait training. This kind of device allows them to walk in a clinical rehabilitation or home environment, and leads to overall health benefits.

To begin using such a device, the first step is to transfer (move the user's body) from the wheelchair into the exoskeleton, usually having the exoskeleton seated in a medical bed or a chair (for example a piano-bench chair). This is the first part of the donning process (also known as putting on the device or fitting). This transition is challenging for patients due to their limited motor function, and depending on their injury type they may require different levels of assistance from a clinician to maintain the balance with their body while performing the transition. It can feel difficult and frustrating to the patient if they cannot perform this transition by themselves without requiring a clinician's support, and in addition, this means that the clinician cannot spend this time performing other valuable tasks.

Current exoskeleton devices address this problem of transferring the patient into the device in various ways:
a) Some devices release the textile straps and rigid supports on the leg brace to have more open space inside the device to perform the body transition. Then, it is expected from a patient to “jump” over the leg brace of the exoskeleton (see FIG. 1A). A potential disadvantage of the “jump” method is that it may increase the risk of falling (losing balance) or getting injured (skin issue, wound or sore) while performing the transfer, as it can be difficult for some patients to overcome the leg brace safely without hitting a part of the mechanical structure with their body. Additionally, it requires from the patient to acquire skills through practice. Many patients with severe neurological injuries and limited hand functions or push-down performance may not be candidates for this technology because of the difficulty in achieving safe transfer. Most of the time it requires the support of a clinician to perform the transition.
b) Others offer a hip joint that can open laterally (hip abduction movement), i.e. around a vertical axis (A1) to allow the patient to transfer inside without the leg being in the way (see FIG. 1B). In these type of devices, at the hip of the exoskeleton there is one mechanical joint 11 for movement in the sagittal plane (for walking movements) and another separate joint 11′ for lateral movement in the frontal plane (for the transfer). The lateral opening of the hip joint (hip abduction movement) is easier for patients to use as there is open space to fit inside the device, but adds extra complexity to the device design. The hip of the exoskeleton needs an additional joint mechanism 11′, and these additional moving rigid components increase the manufacturing cost of the device and make the structure less rigid, and more likely to suffer mechanical failures. After the transfer is completed, this lateral movement joint 11′ is not used in the operation of the exoskeleton for any other task. Additionally, with this transfer method, when the leg is closed (hip adduction movement) by the user to complete the fitting of the exoskeleton, there may be a risk of pinching the skin (skin issue) of the patient with the joint mechanism of the exoskeleton.
c) Other devices address this problem by designing their product into modular rigid parts (usually 5 parts: lumbar section, right and left leg, and right and left foot) that can be fitted to the body independently and later snap-together (assembled and disassembled together) while the user is seated. While this facilitates transportation (as the different parts of the exoskeleton can then be placed inside a bag) and putting on the exoskeleton directly from a wheelchair (thus avoiding unnecessary transitions to a chair), it's not the best solution in the clinical setting because, in the end, it increases the time for donning as all the parts need to be assembled together. In addition, having modular parts reduces the robustness of the mechanical structure of the system, increasing the play between the parts of the exoskeleton and the risk of mechanical failure, and the durability of the system (as electronic components suffer mechanical loads and are constantly connected and disconnected).

Therefore, it would be desirable for an exoskeleton to include means to allow performing this transition into the device in the easiest and fastest way possible, with maximum patient independence and the least complexity possible, while maintaining the exoskeleton robustness and durability.

### SUMMARY

A first aspect of the invention relates to a system to assist walking, comprising two orthoses, wherein the two orthosis comprise a first articulation for the hip articulation of each of the user's leg and a thigh segment, connected to the first articulation. At least one orthosis further comprises a first fixing mechanism configured to fix the first articulation. The system is characterised in that the at least one orthosis is configured to be set into a user transfer position, wherein in the user transfer position the first fixing mechanism is configured to fix the thigh segment at an angle of at least 60° with respect to the thigh segment of the opposite orthosis.

In a preferred embodiment, the at least one orthosis further comprises a second articulation for the knee articulation of the user's leg, and a second fixing mechanism configured to fix the second articulation; and the system is further characterized in that in the user transfer position the second fixing mechanism is configured to fix the second articulation at a flexion angle of at most 45°.

A second aspect of the invention relates to a system to assist walking comprising at least one orthosis for a user's leg. Said orthosis comprises: a first articulation for the hip articulation of the user's leg, a thigh segment connected to the first articulation, a first fixing mechanism configured to fix the first articulation, a first sensor configured to determine the position of the thigh segment, and a control unit configured to control the first fixing mechanism. The control unit is configured to set the system into a user transfer state, wherein, in the user transfer state, the first fixing mechanism is configured to fix the first articulation into a user transfer position when the angle of thigh segment as determined by the first sensor is at most 30° with the vertical component.

In a preferred embodiment, the said orthosis further comprises: a second articulation for the knee articulation of the user's leg, a shank segment connected to the thigh segment through the second articulation, a second fixing mechanism configured to fix the second articulation, and a second sensor configured to determine the position of the shank segment. The control unit is further configured to control the second fixing mechanism, and in the user transfer state, the second fixing mechanism is configured to fix the second articulation into a user transfer position when the flexion angle of the shank segment as determined by the second sensor is at most 45°.

In another preferred embodiment according to any one of the embodiments of the second aspect of the invention, in the user transfer state, the first fixing mechanism is configured to fix the first articulation into a user transfer position when the angle of thigh segment as determined by the first sensor is at most 5° of the vertical component, preferably in the vertical component and/or the second fixing mechanism is configured to fix the second articulation into a user transfer position when the angle of the shank segment as determined by the second sensor is at most 5° with the vertical component, preferably in the vertical component.

In another preferred embodiment according to any one of the embodiments of the second aspect of the invention, said orthosis further comprises: a first actuator coupled to the first articulation and configured for setting the angle of flexion (αₕ) of the first articulation, wherein the control unit is further configured to control the angle of flexion (αₕ) of the first articulation through the first actuator; and/or a second actuator coupled to the second articulation and configured for setting the angle of flexion (αₖ) of the second articulation, wherein the control unit (50) is further configured to control the angle of flexion (αₖ) of the second articulation through the second actuator. In a more preferred embodiment, the orthosis comprises both the first actuator and the second actuator.

In another more preferred embodiment, the control unit is further configured to set the system into a sit position, wherein, in the sit position, the angle of flexion (αₙ) of the first articulation is set to the angle of flexion wherein the angle of thigh segment as determined by the first sensor is between 70° and 110° with the vertical component, and the angle of flexion (αₖ) of the second articulation is set to the angle of flexion wherein the angle of shank segment as determined by the second sensor is at between 135° and 200° with the vertical component. Moreover, the control unit is only configured to set the system into a user transfer state if the system is previously in a sit position.

In another more preferred embodiment, in the user transfer state, the angle of flexion (αₕ) of the first articulation and the angle of flexion (αₖ) of the second articulation are set by the actuators into a user transfer position to an angle at most 30° with the vertical component as an assistance to a user's movement of the first and second articulations, respectively.

In another preferred embodiment according to any one of the embodiments of the second aspect of the invention, in the user transfer state the control unit is further configured to fix the articulations of the opposite orthosis.

In another preferred embodiment according to any one of the embodiments of the second aspect of the invention, the system further comprises a controller, connected to the control unit and configured to allow the user and/or a therapist to instruct the control unit to set the system into the user transfer state and/or the user transfer position.

A third aspect of the invention relates to a method for moving into and out from a system to assist walking, wherein the system to assist walking is a system to assist walking according to any one of the first or second aspects of the invention. The method comprises:
a. If the system comprises a control unit, instructing the control unit (50) to set the system to assist walking into a user transfer state,
b. setting the first and second articulations into the user transfer position once a certain angle of the first and second articulation is reached by fixing the first articulation and/or the second articulation through the first fixing mechanism and the second fixing mechanism, respectively; and
c. moving the user into or out from the system to assist walking through the side of the at least one orthosis the system has set into the user transfer state.

In a preferred embodiment, the method comprises instructing the control unit to set the system to assist walking into a sit state prior to step a).

In another preferred embodiment according to any one of the embodiments of the third aspect of the invention, the system to assist walking further comprises supports and/or straps, and before step a) the method comprises opening the supports and/or straps.

In another preferred embodiment according to any one of the embodiments of the third aspect of the invention, after step a) and before step b), the method comprises moving the first and/or second articulations to their user transfer position through the assistance of the first and second actuators.

In another preferred embodiment according to any one of the embodiments of the third aspect of the invention, the locking step b) is performed automatically by the control unit once it detects the angles of flexion of the first and/or second articulations have reached their respective user transfer position. In a more preferred embodiment, the method further comprises providing feedback to the user once the locking step b) is performed.

In another preferred embodiment according to any one of the embodiments of the third aspect of the invention, the locking step b) further involves fixing the articulations of the opposite orthosis into place, preferably wherein the control unit is further configured to fix the articulations of the opposite orthosis.

In another preferred embodiment according to any one of the embodiments of the third aspect of the invention, the method further comprises the step of instructing the control unit to set the system to assist walking out from the user transfer state. In a more preferred embodiment, setting the system to assist walking out from the user transfer state of comprises unlocking the first and second articulations from the user transfer position by unfixing the first fixing mechanism and the second fixing mechanism.

A fourth aspect of the invention relates to a computer-implemented method according to any one of the third aspect of the invention.

A fifth aspect of the invention relates to a computer program product, comprising a set of instructions, which when executed by a processor, configure a system to assist walking according to any one of the systems to assist walking according to the first or second aspect of the invention to perform any of the of the methods according to any one of the methods of the third aspect of the invention.

### BRIEF DESCRIPTION OF THE DRAWINGS

To enable a better understanding of the present disclosure, and to show how the present disclosure may be carried out, reference will now be made, by way of example only, to the accompanying schematic drawings, wherein:

FIG. 1 shows prior art systems (A, B) to move into and out from a system to assist walking.

FIG. 2 shows a system to move into and out from a system to assist walking, before (A) and after (B) the system has been set into a user transfer state according to one or more embodiments of the invention.

FIG. 3 shows a diagram of the electronics of the system to assist walking according to one or more embodiments of the invention.

FIG. 4 shows a diagram of a method for moving into and out from a system to assist walking according to one or more embodiments of the invention.

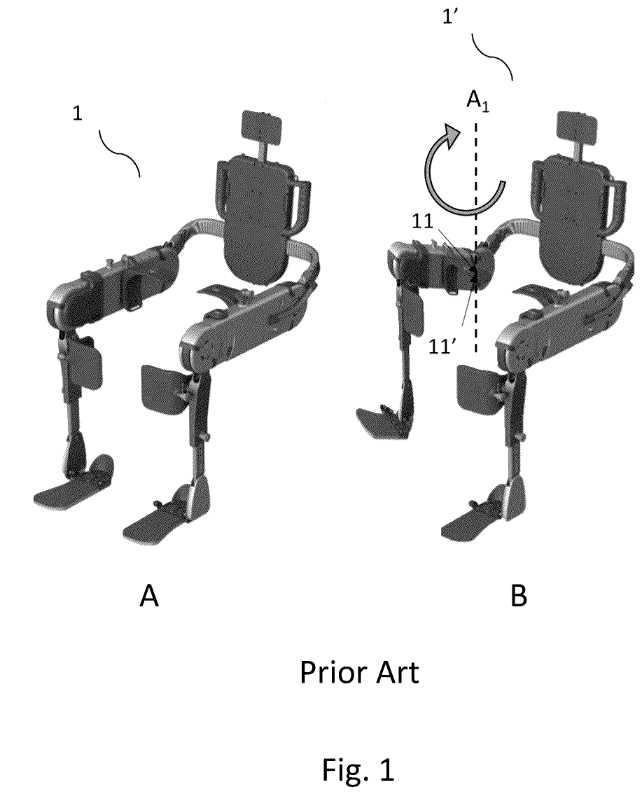

### DETAILED DESCRIPTION

### Definitions

It must be noted that, as used herein, the singular forms “a”, “an”, and “the”, include plural references unless the context clearly indicates otherwise. Further, unless otherwise indicated, the term “at least” preceding a series of elements is to be understood to refer to every element in the series. Those skilled in the art will recognize or be able to ascertain using no more than routine experimentation, many equivalents to the specific embodiments of the invention described herein. Such equivalents are intended to be encompassed by the present invention.

It is noted that the term “about”, as used herein, refers to +/−30%, preferably +/−20%, preferably +/−15%, more preferably +/−10%, of the indicated referred value.

As used herein, the conjunctive term “and/or” between multiple recited elements is understood as encompassing both individual and combined options. For instance, where two elements are conjoined by “and/or”, a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”. Any of the aforementioned terms (comprising, containing, including, having), whenever used herein in the context of an aspect or embodiment of the present invention may be substituted with the term “consisting of”, though less preferred.

When used herein “consisting of” excludes any element, step, or ingredient not specified in the claim element. When used herein, “consisting essentially of does not exclude materials or steps that do not materially affect the basic and novel characteristics of the claim.

The term “system to assist walking”, in the context of the invention, refers to a wearable mechanical system specifically designed to assist in walking and gait training. This system primarily targets the lower limbs and the back, preferably the lower or lumbar segment, but may also include middle or upper segments, to provide mechanical assistance, stability, or support, such as crutches. The system to assist walking may comprise exoskeletons or any mechanical, electromechanical, or software-driven solution designed to aid, enhance, or support walking and gait training functions, such as lower limb braces, walker devices, wheeled or non-wheeled supports and/or programmable foot orthotics.

The term “exoskeleton”, in the context of the invention, refers to a wearable mechanical system specifically designed to assist in walking and gait training. This system primarily targets the lower limbs and the back, preferably the lower or lumbar segment, but may also include middle or upper segments, to provide mechanical assistance, stability, or support. Complementary devices such as crutches may also be comprised within the term exoskeleton when associated to a wearable mechanical system as above-defined. The exoskeleton may be operatively connected to control units or software that enable its functions.

The term “user transfer position”, in the context of the invention, refers to having a system to assist walking, preferably an exoskeleton in a mechanical configuration in which the user can transfer from a wheelchair/chair/bed into the system to assist walking and from the system to assist walking back into the wheelchair/chair/bed.

The term “lumbar segment”, in the context of the invention, refers to a mechanical or electromechanical component specifically designed to support, stabilize, or aid the lumbar region of the back.

The term “thigh segment”, in the context of the invention, refers to a mechanical or electromechanical component tailored to encompass, support, or assist the upper leg area between the hip and the knee. This segment may be operatively connected to control units, software, or sensors that enable its functions and gather information on its position, movement, and/or angle of inclination.

The term “shank segment”, in the context of the invention, refers to a mechanical or electromechanical component designed to support or assist the lower leg area between the knee and the ankle. This segment may be operatively connected to control units, software, or sensors that enable its functions and gather information on its position, movement, and/or angle of inclination.

### Description

Each embodiment disclosed herein is contemplated as being applicable to each of the other disclosed embodiments. Thus, all combinations of the various elements described herein are within the scope of the invention. It should also be understood that, unless clearly indicated to the contrary, in any methods claimed herein that include more than one step or act, the order of the steps or acts of the method is not necessarily limited to the order in which the steps or acts of the method are recited A first aspect of the invention relates to a system to assist walking allowing the user to move into and out from it by comprising at least one orthosis 100 which can be set into a position wherein a first articulation for the hip articulation of the user's leg is fixed in a position that facilitates such movement.

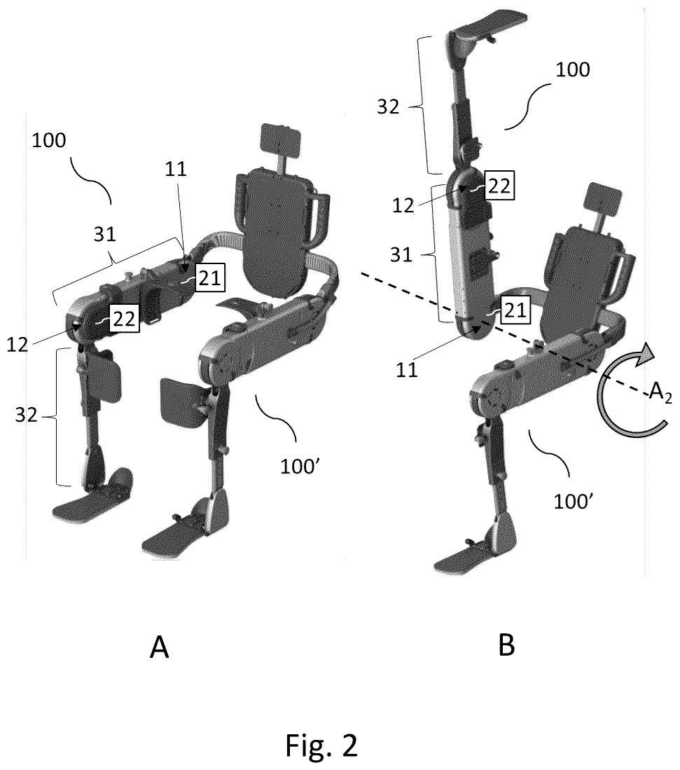

Particularly, and as shown with respect to FIG. 2, the invention relates to a system to assist walking comprising two orthoses 100, 100′, wherein the two orthoses comprise a first articulation 11, 11′ for the hip articulation of each of the user's leg, and a thigh segment 31, 31′, connected to the first articulation 11, 11′, where at least one orthosis 100 further comprises: a. a first fixing mechanism 21 configured to fix the first articulation 11. The invention is characterised in that the at least one orthosis is configured to be set into a user transfer position, wherein in the user transfer position the first fixing mechanism 21 is configured to fix the thigh segment 31 at least one orthosis 100 at an angle of at least 60° with respect the thigh segment 31′ of the opposite orthosis 100′.

It is noted that the system to assist walking may comprise a wide array of mechanical, electromechanical, or robotic devices and technologies designed to aid, support, or enhance the walking or gait capabilities of a user. Such systems may include, but are not limited to, exoskeletons, orthotic devices, powered or unpowered limb supports, and wearable assistive technologies. Specifically, these systems are constructed to interface with the lower extremities of the human body, including the legs and preferably the feet, and may also extend to include supportive structures for the back or spine, the head or the upper limbs. The system may be designed for various purposes including rehabilitation, gait training, mobility enhancement, and other applications where assisted walking or gait functionality is required. Therefore, the term “system to assist walking” should be construed in its broadest sense, encompassing all devices and technologies that align with the aforementioned functionalities, unless explicitly specified otherwise.

It is noted that the first articulation 11, 11′ may be designed through different mechanical solutions that allow the movement of the orthosis 100 around the hip rotation axis. The skilled person may envisage many different alternative articulation solutions for the first articulation 11, 11′ which can allow the movement of the orthosis 100 around the hip rotation axis, all of which are comprised within this disclosure.

It is also noted that the thigh segment 31 may be designed in different ways, including material shapes, compositions and functionalities. The skilled person may envisage many different thigh segments that could be used as the thigh segment 31 for a system to assist walking. It is considered that any element of a system to assist walking associated to the thigh of the user and is connected to the first articulation 11 are comprised within this disclosure.

It is also noted that the first fixing mechanism 21 may involve many different solutions, such as a pass though volt, a lever, a ratchet associated to a clutch or any other mechanism that can affix two element that move relative to one another around an axis in a determine position, such that they cannot longer move relative to one another around such axis. Thus, the present invention is not limited whatsoever in terms of the different fixing mechanisms the fixing mechanism may involve, including electromechanical and electromagnetic solutions, such as a motor or an electromagnet. Although FIG. 2 shows the first fixing mechanism 21 located nearby the first articulation 11, in other embodiments, the first fixing mechanism may comprise one or more elements located in other parts of the orthosis 100 or the system to assist walking, such as wires, cable or actuation mechanisms.

Advantageously, having the first fixing mechanism 21 configured to fix the thigh segment 31 of the at least one orthosis 100 at an angle of at least 60° with respect to the thigh segment 31′ of the opposite orthosis 100′ means that the at least one orthosis 100 can be manipulated to set its first articulation 11 into an angle of at least 60° upon which, the first fixing mechanism 21 will fix such first articulation 11 into place. A system to assist walking with the first articulation 11 for the hip articulation of the user's leg at an angle of at least 60° with respect to the first articulation 11′ of the opposite orthosis 100′ provides a lateral space wherein the user can move onto or out from the exoskeleton. Thus, the at least one orthosis 100 is configured to be set into a position that provides a lateral space wherein the user can move onto or out from the exoskeleton The system to assist walking herein presented provides means to allow performing this transition of the user into and out from the systemin a very easy and fast way, by simply moving the thigh segment 31 of the at least one orthosis 100 to a certain angle with respect to the thigh segment 31′ of the opposite orthosis 100′. Moreover, it can be done in the easiest and fastest way possible, with maximum patient independence and the least complexity possible, while maintaining the exoskeleton robustness and durability.

It is noted that the first fixing mechanism 21 be only configured to fix the thigh segment 31 at an angle of at least 60° with respect to the thigh segment 31′ of the opposite orthosis 100′ once a certain condition has been met, either electronically or mechanically. Thus, for example, a mechanical switch may be established that enables the first fixing mechanism 21 to effectively fix the first articulation 11. Alternatively, an electronic state may be used to determine when the first fixing mechanism shall work as such. This may further serve as a safety measure configured to prevent an involuntary fixation of the first articulation 11 by the first fixing mechanism 21.

According to preferred embodiment, the first fixing mechanism 21 is configured to fix the thigh segment 31 into a user transfer position at an angle of at least 61°, more preferably, at least 62°, even more preferably at least 63°, 64°, 65°, 66°, 67°, 68, 69°, 70°, 71°, 72°, 73°, 74°, 75°, 76°, 77°, 78°, 79°, 80°, 81°, 82°, 83°, 84°, 85°, 88°, 89°, even further more preferably at least 90° with respect to the thigh segment 31′ of the opposite orthosis 100′. This further increases the lateral space left by the orthosis.

It is noted that FIG. 2 shows a system to move into and out from a system to assist walking, according to one or more embodiments of the invention. However, it comprises multiple optional elements according to this embodiment of the first aspect of the invention. For example, the at least one orthosis 100 of FIG. 2 comprises a shank segment 32, a second articulation 12, that may be optional according to one or more embodiments of the invention. It is also noted that a particular system to assist walking and a particular orthosis is shown in FIG. 2, however, other shapes, sizes or solutions may be employed in different particular embodiments of this embodiment of the first aspect of the invention. For example, in some other embodiments of this aspect of the invention the system to assist walking may not comprise a lumbar segment, or may comprise a simpler lumbar segment, such as a bar joining both orthoses 100, 100′.

In a preferred embodiment of the first aspect of the invention, and as shown with respect to FIG. 2, the at least one orthosis 100 further comprises: c. a second articulation 12 for the knee articulation of the user's leg and d. a second fixing mechanism 22 configured to fix the second articulation 12. The invention is characterised in that in the user transfer position the second fixing mechanism 22 is configured to fix the second articulation 12 at a flexion angle of at most 45°.

It is noted that in humans, the knee flexion movement is measured as the angle between the axis defined by the thigh and the axis defined by the shank of the human. Thus, for example, a human standing up with the legs extender would have a knee flexion angle of 0°, while a human kneeled, would have a knee flexion angle of 90°.

All the above-mentioned notes regarding the first articulation 11 of the at least one orthosis 100 can be applied, mutatis-mutandis, to the second articulation 12 of the at least one orthosis 100. Likewise, all the above-mentioned notes regarding the first fixing mechanism 21 can be applied, mutatis-mutandis, to the second fixing mechanism 22.

Advantageously, further having the second fixing mechanism 22 configured to fix the second articulation 12 at a flexion angle of at most 45°, means that the orthosis can be manipulated to set the second articulation 12 into a flexion angle of at most 45° upon which, the second fixing mechanism 22 will fix such second articulation 12 into place. A system to assist walking further having the second articulation 12 for the knee articulation of the user's leg at an angle of at most 45°, further provides a lateral space wherein the user can move onto or out from the exoskeleton.

It is noted that the second mechanism 22 may be only configured to fix the second articulation 12 at a flexion angle of at most 45° once a certain condition has been met, either electronically or mechanically. Thus, for example, a mechanical switch may be established that enables the second fixing mechanism 22 to effectively fix the second articulation 12. Alternatively, an electronic state may be used to determine when the second fixing mechanism shall work as such. This may further serve as a safety measure configured to prevent an involuntary fixation of the second articulation 12 by the second fixing mechanism 22. Alternatively or additionally, the second fixing mechanism 22 may work together with the fist fixing mechanism, such that they only fix their respective articulations when both have their safety condition met, or may share the same safety condition. Alternatively or additionally, the second fixing mechanism 22 may only fix the configured to fix the second articulation 12 once the first fixing mechanism 21 has fixed the the first articulation 11, or vice versa.

According to preferred embodiment, the second fixing mechanism 22 is configured to fix the second articulation 12 into a user transfer position at a flexion angle of at most 44°, more preferably at most 43°, even more preferably at most 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2°, 1°, and even further more preferably at most 0°. This further increases the lateral space left by the orthosis.

It is noted that FIG. 2 comprises multiple optional elements according to this preferred embodiment of the first aspect of the invention. For example, the orthosis 100 of FIG. 2 comprises a lumbar segment that may be optional according to one or more embodiments of the invention. It is also noted that a particular system to assist walking and a particular orthosis is shown in FIG. 2, however, other shapes, sizes or solutions may be employed in different particular embodiments of this embodiment of the first aspect of the invention.

It is noted that any of the embodiment of the first aspect of the invention may be implemented in mechanical-based systems to assist walking, for example those relying on springs to assist users to walk. Therefore, there is no need for the system to assist walking to comprise any electrical, or electromechanical elements in order to effectively solve to perform this transition of the user into and out from the system in a very easy and fast way in the easiest and fastest way possible, with maximum patient independence and the least complexity possible, while maintaining the exoskeleton robustness and durability.

A second aspect of the invention, and as shown with regard to FIG. 2 relates to a system to assist walking, comprising at least one orthosis 100 for a user's leg, where said orthosis 100 comprises:
a. a first articulation 11 for the hip articulation of the user's leg,
b. a thigh segment 31 connected to the first articulation 11,
c. a first fixing mechanism 21 configured to fix the first articulation 11,
d. a first sensor 41 configured to determine the position of the thigh segment 31, and
e. a control unit 50 configured to control the first fixing mechanism 21.

The control unit 50 is configured to set the system into a user transfer state. In the user transfer state, the first fixing mechanism 21 is configured to fix the first articulation 11 into a user transfer position when the angle of thigh segment 31 as determined by the first sensor 41 is at most 30° with the vertical component.

It is noted that all characteristics and notes regarding the first articulation 11 of the orthosis 100 of the first aspect of the invention, can be likewise applied, to the first articulation 11 of the second aspect of the invention. Likewise, all characteristics and notes regarding the first fixing mechanism 21 of the orthosis 100 of the first aspect of the invention, can be likewise applied, to the first fixing mechanism 21 of the second aspect of the invention.

It is also noted that the thigh segment 31 may be designed in different ways, including material shapes, compositions and functionalities. The skilled person may envisage many different thigh segments that could be used as the thigh segment 31 for a system to assist walking. It is considered that any element of a system to assist walking associated to the thigh of the user and is connected to the first articulation 11 are comprised within this disclosure.

It is also noted that the first sensor 41 may comprise one or more sensors. The sensor 41 may comprise a broad category of sensing devices and technologies integrated into or used in conjunction with the first articulation 11 for the purpose of determining the positions, movements, and/or orientations of the thigh segment 31, associated to the positions, movements, and/or orientations of the thigh of the user. Types of sensors may encompass, but are not limited to, angle sensors, orientation sensors, accelerometers, gyroscopes, magnetometers, potentiometers, force sensors, pressure sensors, optical sensors, and other emerging or existing sensing technologies. These sensors are capable of measuring a range of kinematic and kinetic variables including, but not limited to, angular velocity, acceleration, force, torque, orientation, and displacement. The acquired data aids in assessing the state and motion of the lower limbs and back, thereby enabling the precise control, adjustment, and monitoring of the assistive walking or gait system. The skilled person may envisage how one or more of the afore-mentioned sensors may be combined to achieve a first sensor 41 configured to determine the position of the thigh segment 31 with respect to a reference point, such as gravity, from wherein the relative position to the vertical component can be easily computed. This reference point may be obtained continuously or the first sensor 41 may be calibrated beforehand.

It is further noted that the control unit 50 may comprise a comprehensive array of computing hardware, firmware, and/or software modules designed to manage, coordinate, and control the functionalities of the walking assistive system, such as an exoskeleton. The control unit may include microcontrollers, microprocessors, digital signal processors, application-specific integrated circuits (ASICs), field-programmable gate arrays (FPGAs), or other computational elements capable of executing algorithms and control logic. Although throughout the description the control unit may be assigned to the orthosis 100, it is noted that in other embodiments of the present invention the control unit 50, may also be comprised, partially or totally in the system to assist walking.

The user transfer state can be understood as both the physical state of the orthosis 100 and/or as a state of the control unit 50, wherein the first fixing mechanism 21 is configured to fix the first articulation 11 into a user transfer position when the angle of thigh segment 31 as determined by the first sensor 41 is at most 30° with the vertical component.

Advantageously, having the control unit 50 configured to set the system into the user transfer state for the first fixing mechanism 21 configures the system to assist walking to allow performing this transition of the user into and out from the system in a very easy and fast way, by simply fixing this first mechanism once a certain angle is determined by the first sensor 41. Moreover, this is done with maximum patient independence and the least complexity possible, while maintaining the exoskeleton robustness and durability.

FIG. 2A shows a system to assist waling wherein the orthosis 100 is in the user transfer state, but wherein the first fixing mechanism 21 has not yet been fixed, as the first sensor 41 has determined that the angle of the thigh segment 31 is more than 30° with the vertical component, particularly around 90°. Thus the orthosis 100 is in a resting position, touching the ground. However, in FIG. 2B it can be seen the same system to assist walking wherein the orthosis 100 is also in the user transfer state, but wherein the first fixing mechanism 21 has been fixed, as the first sensor 41 has determined that the angle of the thigh segment 31 is less than 30° with the vertical component. It is noted that the angle of the thigh segment 31 is not determined relative to any other element of the system to assist walking, and as shown in FIG. 2B, the angle may be achieved with the compliance of a lumbar segment, which can also lean backwards to facilitate the thigh segment 31 reaching a determined angle. Now that the first fixing mechanism has been fixed, it can be noticed how the user can now easily transfer to the system to assist walking, by moving into or out from it laterally, for example from a wheelchair. It is noted that FIG. 2 shows a system to move into and out from a system to assist walking, according to one or more embodiments of the invention. However, it comprises multiple optional elements according to this embodiment of the second aspect of the invention. For example, the orthosis 100 of FIG. 2 comprises a lumbar segment a shank segment 32, a second articulation 12, that may be optional according to one or more embodiments of the invention. It is also noted that a particular system to assist walking and a particular orthosis is shown in FIG. 2, however, other shapes, sizes or solutions may be employed in different particular embodiments of this embodiment of the first aspect of the invention.

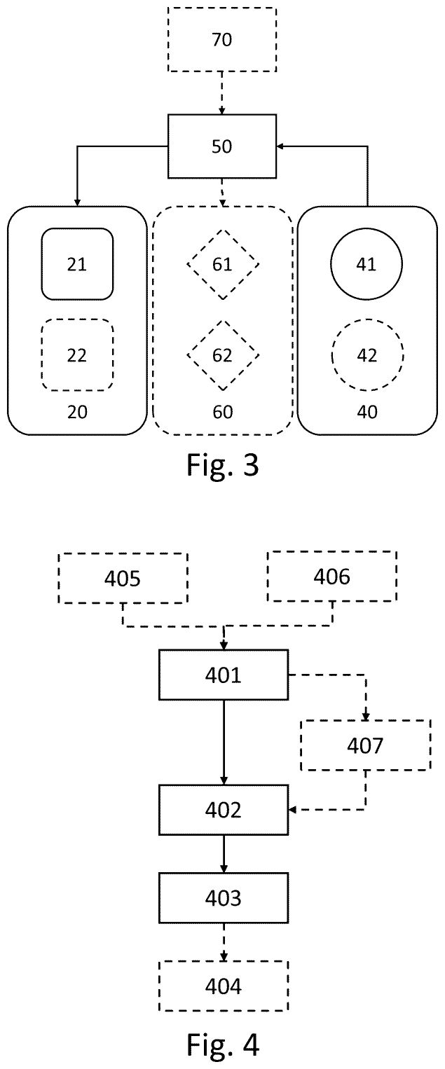

FIG. 3 shows a diagram of the electronics of the system to assist walking, wherein it can be seen how the control unit 50 receives information from one or more sensors 40, and uses such information to actuate or send the information needed, such as a state change to one or more fixing mechanisms (20) to fix a particular articulation in place. It is noted that FIG. 3 shows many other elements such as one or actuators 60 or a controller 70 that are optional and may not be comprised in all the embodiment so the second aspect of the invention.

According to a preferred embodiment, the first fixing mechanism 21 is configured to fix the first articulation 11 into a user transfer position when the angle of thigh segment 31 as determined by the first sensor 41 is at most 29° with the vertical component, more preferably at most 28° with the vertical component, even more preferably, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2°, 1°, further preferably in the vertical component. Advantageously, this further configures the system to assist walking to further facilitate moving into and out from the system to assist walking.

In a preferred embodiment of the second aspect of the invention, and as also shown with respect to FIG. 2, the orthosis further comprises:
f. a second articulation 12 for the knee articulation of the user's leg,
g. a shank segment 32 connected to the thigh segment 31 through the second articulation 12,
h. a second fixing mechanism 22 configured to fix the second articulation 12, and
i. a second sensor 42 configured to determine the position of the shank segment 32.

In this preferred embodiment, the control unit 50 is further configured to control the second fixing mechanism 22, and in the user transfer state, the second fixing mechanism 22 is configured to fix the second articulation 12 into a user transfer position when the flexion angle of the shank segment 32 as determined by the second sensor 42 is at most 45°.

It is noted that in humans, the flexion angle of the shank segment movement is measured as the angle between the axis defined by the thigh and the axis defined by the shank of the human. Thus, for example, a human standing up with the legs extender would have a knee flexion angle of 0°, while a human kneeled, would have a knee flexion angle of 90°.

All the above-mentioned notes regarding the first articulation 11 can be applied, mutatis-mutandis, to the second articulation 12. Likewise, all the above-mentioned notes regarding the first fixing mechanism 21 can be applied, mutatis-mutandis, to the second fixing mechanism 22. Similarly, all the above-mentioned notes regarding the thigh segment 31 can be applied, mutatis-mutandis, to the shank segment 32. It is considered that any element of a system to assist walking associated to the shank of the user and connected to the thigh segment 31 through the second articulation 12 are comprised within this disclosure. Also, all the above-mentioned notes regarding the first sensor 41 can be applied, mutatis-mutandis, to the second sensor 42. Therefore, the sensor 42 may comprise a broad category of sensing devices and technologies integrated into or used in conjunction with the second articulation 12 for the purpose of determining the positions, movements, and/or orientations of the shank segment 32, associated to the positions, movements, and/or orientations of the shank of the user.

Advantageously, further having the second fixing mechanism 22 configured to fix the second articulation 12 when the flexion angle of the shank segment 32 as determined by the second sensor 42 is at most 45°, configures the system to assist walking to allow performing this transition of the user into and out from the system in an ever easier and faster way, by simply fixing this second mechanism 22 once a certain angle is determined by the second sensor 42, allowing the shank segment to be also out of the way of the transfer movement path. Moreover, this is also done with the least complexity possible only using already available components in most of the systems to assist walking, while maintaining the robustness and durability.

FIG. 2A shows a system to assist waling wherein the orthosis 100 is in the user transfer state, but wherein the second fixing mechanism 22 has not yet been fixed, as the second sensor 42 has determined that the flexion angle of the shank segment 32 is more than 45°, particularly around 180°. Thus the orthosis 100 is in a resting position, touching the ground. However, in FIG. 2B it can be seen the same system to assist walking wherein the orthosis 100 is also in the user transfer state, but wherein the second fixing mechanism 22 has been fixed, as the second sensor 42 has determined that the flexion angle of the shank segment 32 is less than 45°. It is noted that the angle of the shank segment 32 is not determined relative to any other element of the system to assist walking, and as shown in FIG. 2B, the angle may be achieved with the compliance of a lumbar segment, which can also lean backwards to facilitate the shank segment 32 reaching a determined angle. Now that the first fixing mechanism has been fixed, it can be noticed how the user can now easily transfer to the system to assist walking, by moving into or out from it laterally, for example from a wheelchair.

According to a preferred embodiment, the second fixing mechanism 22 is configured to fix the second articulation 12 into a user transfer position when the angle of shank segment 31 as determined by the second sensor 42 is at most 44° with the vertical component, more preferably at most 43° with the vertical component, even more preferably, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2°, 1°, further more preferably at most 0°. According to a preferred embodiment, the Advantageously, this further configures the system to assist walking to further facilitate moving into and out from the system to assist walking.

It would be even more helpful to some users, particularly to those with severe impairment, to be able to not only set the system to assist walking into the transfer state, but to be further assisted into setting the first and/or second segments 31, 32 into the appropriate angles with respect to the vertical component without requiring a therapist or other human.

According to a preferred embodiment, and as shown with respect to FIG. 3, the orthosis 100 further comprises:
j. a first actuator 61 coupled to the first articulation 11 and configured for setting the angle of flexion (αₕ) of the first articulation 11, wherein the control unit 50 is further configured to control the angle of flexion (αₕ) of the first articulation 11 through the first actuator 61; and/or
k. a second actuator 62 coupled to the second articulation 12 and configured for setting the angle of flexion (αₖ) of the second articulation 12, wherein the control unit 50 is further configured to control the angle of flexion (αₖ) of the second articulation 12 through the second actuator 62;

It is noted that the first and/or second actuators 61, 62 may be any type of electrical or mechanical systems that enables setting the angle of flexion first and/or second articulation 11, 21, respectively. The skilled person may envisage many different approaches to the first and/or second actuators 61, 62, such as an electrical motor, a stepping motor a brushless motor, a spring actuated mechanism, etc. all of which are comprised within the present disclosure. It is also noted that the first and/or second actuators 61, 62 may be the same element than the first and/or second fixing mechanism 21, 22, for example an electrical motor, a stepping motor a brushless motor or a spring actuated mechanism.

Advantageously, having the control unit 50 further configured to control the angle of flexion of the articulations 11, 12 through the actuator 61, 62, enables multiple solutions to assist the user into setting the system to assist walking into a position which provides enough room to laterally transfer into or out from the system to assist walking without requiring help from other persons, as will be described later below. It is noted that most systems to assist walking may already comprise actuators for its articulations, and therefore, this does not further increase the complexity or weight of the system to assist walking in most cases.

According to a further preferred embodiment, the orthosis 100 comprises both the first actuator 61 and the second actuator 62. Advantageously, this further contributes into assisting the user, as both segments 11, 12 can be controlled through the control unit.

According to another further preferred embodiment, the control unit 50 is further configured to set the system to assist walking into a sit position, wherein, in the sit position, the angle of flexion (an) of the first articulation 11 is set to the angle of flexion wherein the angle of thigh segment 31 as determined by the first sensor 41 is between 70° and 110° with the vertical component, and the angle of flexion (αₖ) of the second articulation 12 is set to the angle of flexion wherein the angle of shank segment 32 as determined by the second sensor 42 is at between 135° and 200° with the vertical component.

In this further preferred embodiment, the control unit 50 is only configured to set the system into a user transfer state if the system is previously in a sit position.

Advantageously, having to have the system to assist walking set into the sit position prior to a user transfer state, ensures that the system to assist walking is into a position and on a surface, that allows an easy transfer for the user into and out from the system once the segments 11, 12 are fixed by the first and second fixing mechanisms 21, 22, respectively.

It is noted that the angles of the first and second articulations 11, 12 as defined in this more preferred embodiment, comprise suitable combination in which a system to assist walking would comfortably be into a position where the user of the system could sit onto a chair or a bench, for example. It is noted that the control unit 50 may use different sensors, or an additional input form the user to determine the appropriate angles of the thigh segment 31 and the shank segment 32 to accommodate to a particular surface, which may vary on its height. For example there may be a pressure sensor, or the user may press a button to set the desired position.

According to another further preferred embodiment, in the user transfer state, the angle of flexion (αₕ) of the first articulation 11 and the angle of flexion (αₖ) of the second articulation 12 are set by the actuators into a user transfer position to an angle at most 30° with the vertical component as an assistance to a user's movement of the first and second articulations 11, 12, respectively.

Advantageously, this allows the same user that is wearing the system to assist walking or another person such as a therapist, for example, to not need to carry the weight of the orthosis 100 when moving the thigh segment 31 and the shank segment 32 into the transfer position. This further makes the system to be able to help the user to move into and out form the system in an even more easy way possible.

In some particular embodiment, the first and/or second articulations 11, 12 may be completely set into set into an angle such that their respective segments are at most 30° with the vertical component completely on their own. In this embodiments, a safety system may be introduced to avoid such movement when the user's limb is attached to the orthosis. This further makes the system to be able to help the user to move into and out form the system in the easiest and fastest way possible.

According to another preferred embodiment, in the user transfer state the control unit 50 is further configured to fix the articulations of the opposite orthosis. It is noted that the systems to assist walking comprise an orthosis for each leg, and thus it is desirable for the control unit 50 to be able to also interact with the opposite orthosis, particularly to fix its articulations into place.

In the embodiments, wherein the control unit 50 is only configured to set the system into a user transfer state if the system is previously in a sit position, this means that the opposite orthosis is fixed into a sit position. Advantageously, this provides an additional support to the system to assist walking to maintain its position while the user move into or out form it, and a reliable support for the user.

According to another preferred embodiment, and as shown in FIG. 3, the system further comprises a controller 70, connected to the control unit 50 and configured to allow the user and/or a therapist to instruct the control unit 50 to set the system into the user transfer state and/or the user transfer position.

The controller may be any type of interface from wherein the user can instruct the control unit 50 to be set into the user transfer state. For example, the controller 70 may be a simple button, a digital display, a touchscreen, a voice-assistant, a dial, a knob, or any other interface the skilled person may envisage.

The controller 70 may be also, or alternatively controlled by another person, such as a therapist. In some embodiments the controller 70, may further set the control unit 50 to det the orthosis 100 into the sit position, and/or may be able to determine parameters from the user transfer state and/or the sit position, such as the speed, position, and/or assistance needed. Advantageously, having a controller facilitates the user and/or a therapist to control the system and determining when and how to set the user transfer state.

All of the above embodiments of the first and second aspect of the invention relate to systems to assist walking comprising at least one orthosis 100 for a user's leg as above-described. It is therefore noted that in some embodiments according to any of the embodiments of the first and second aspect of the invention, the system to assist walking comprises two orthoses 100, 100′ for a user's leg as above-described. Advantageously, this allows the user to be able to move into or out from the system to assist walking from any desired side.

A third aspect of the invention, and as shown with respect to FIG. 4 relates to method for moving into and out from a system to assist walking wherein the system to assist walking is a system to assist walking according to any one of aspects one or two of the present invention. The method comprises, the following steps:

In a first step 401, if the system comprises a control unit 50, instructing the control unit 50 to set the system to assist walking into a user transfer state. It is noted that the systems to assist walking according to the first aspect of the invention do not comprise a control unit 50, and thus this step is skipped on such systems. The systems to assist walking according to the second aspect of the invention may be set into the user transfer state, in many ways, including using actuators 60, a control unit 70 and setting previously the system to assist walking into a sit position.

In a second step 402, the method involves setting the first and second articulations 11, 12 into the user transfer position by fixing the first articulation 11 and/or the second articulation 12 through the first fixing mechanism 21 and the second fixing mechanism 22, respectively.

It is noted that the systems to assist walking according to the first aspect of the invention may do this once a certain angle is reached, while the systems to assist walking according to the second aspect of the invention may do this once a certain angle with respect to the vertical component is reached. Also this may be done in many ways, including using actuators 60, a control unit 70 and setting previously the system to assist walking into a sit position.

Finally, in a third step 403, the method involves moving the user into or out from the system to assist walking through the side of the at least one orthosis 100 the system has set into the user transfer state. It is noted that the user may move by itself or with the help of another person, such as a therapist. It is also noted, that in this step the user may move partially through the side of the at least one orthosis 100, such that it employs part of the space the orthosis used while in the transfer state before being fixed into the transfer position.

Advantageously, this method allows the user to move into and out from the system in a very easy and fast way, with maximum patient independence and the least complexity possible, while maintaining the robustness and durability of the system to assist walking.

It is noted that FIG. 4 comprises other method steps, 404, 405, 406 and 407 marked with dashed lines, not comprised within this embodiment and that may be also optional in other embodiments of the thirds aspect of the invention.

In a preferred embodiment, the step 402 further involves fixing the articulations of the opposite orthosis into place. In a more preferred embodiment, the control unit 50 is further configured to fix the articulations of the opposite orthosis. Advantageously, this provides an additional support to the system to assist walking to maintain its position while the user move into or out form it, and a reliable support for the user, as the opposite orthosis cannot change its position. According to another preferred embodiment, the method comprises the step 405 of instructing the control unit 50 to set the system to assist walking into a sit position prior to step 401. Advantageously, having to have the system to assist walking set into the sit position prior to a user transfer state, ensures that the system to assist walking is into a position and on a surface, that allows an easy transfer for the user into and out from the system once the segments 11, 12 are fixed by the first and second fixing mechanisms 21, 22, respectively.

According to another preferred embodiment, the system the method comprises to assist walking further comprises supports and/or straps associated to the orthosis, and before step 401 the method comprises the step 406 of opening the supports and/or straps. Advantageously, this facilitates the user into moving into and out from the system to assist walking, and ensure that the system to assist walking is not step into the user transfer position with the orthosis 100 attached to the leg of the user, which could be harmful.

According to another preferred embodiment, after step 401 and before step 402, the method comprises the step 407 of moving the first and/or second articulations 11,12 to their user transfer position through the assistance of the first and/or second actuators 61, 62.

Advantageously, this allows the same user that is wearing the system to assist walking or another person such as a therapist, for example, to not need to carry the weight of the orthosis 100 when moving the thigh segment 31 and the shank segment 32 into the transfer position. This further makes the system to be able to help the user to move into and out form the system in an even more easy way possible.

According to another preferred embodiment, the step 402 is performed automatically by the control unit 50 once it detects the angles of flexion of the first and/or second articulations 11, 12 have reached their respective user transfer position.

Advantageously, this further makes the system to assist walking easier and simpler to use for the user wearing the system, as it does not require an effort to put the orthosis into the user transfer position.

In a more preferred embodiment, the method further comprises providing feedback to the user once the step 402 is performed. It is noted that the feedback may be provided by different means. For example, in some embodiments the feedback may be provided by the controller 70. In some other embodiments, the orthosis 100 or the system to assist walking may comprise an additional element such as an LEF, speaker or haptic motor configured to provide such feedback in the form of a light, sound or vibration. It is noted that in some embodiments, such as those not comprising a control unit 50, the feedback may be provided mechanically through a mechanism configured to provide such feedback once the first and/or second articulation 11,12 is fixed. For example, this may comprise a colored code slider that turns to a particular color, such as green once the first and/or second articulation 11, 12 is fixed. Another example may comprise a clicking mechanism that produces a particular noise as feedback once the first and/or second articulation 11, 12 is fixed. All of these alternatives, their combinations and the many different alternatives the skilled person may envisage are comprised within this disclosure.

According to another preferred embodiment, the method further comprises the step 404 of instructing the control unit 50 to set the system to assist walking out from the user transfer state.

Advantageously, instructing the control unit 50 to set the system to assist walking out from the user transfer state allows the control unit 50 to perform the rest of functions they are typically involved into such as entering into sitting, standing and/or walking modes.

In a more preferred embodiment, setting the system to assist walking out from the user transfer state of comprises unlocking the first and second articulations 11, 12 from the user transfer position by unfixing the first fixing mechanism 21 and the second fixing mechanism 22. In some embodiments, this may involve instructing the control unit 50 to set the system to assist walking into a sitting state, comprising setting the orthosis into a sitting position.

A fourth aspect of the invention relates to a computer implemented method according to any of the methods of the third aspect of the invention.

A fifth aspect of the invention relates to a computer program product comprising a set of instructions, which when executed by a processor, configure a system to assist walking according to the first or second aspect of the invention to perform any of the of the methods of the third aspect of the invention. It is noted that the processor may comprise one or more processing units, such as a microprocessor, GPU, CPU, multi-core processor or the like.

The computer program product may be stored in a memory. The memory may comprise one or more volatile or non-volatile memory devices, such as DRAM, SRAM, flash memory, read-only memory, ferroelectric RAM, hard disk drives, floppy disks, magnetic tapes, optical disks or the like.

### EXAMPLE

A particular implementation of a system and method for moving into and out from a system to assist walking according to the present invention is now described.

### Device

An exoskeleton device (that we have named “ABLE Exoskeleton”-described in patent application numbers US20190231573, EP20383088, EP22382778) that can lock all joints into the transfer position with Yoga Leg.

The ABLE Exoskeleton is a wearable powered lower-limb exoskeleton that actively assists individuals with impairments to stand up, walk and sit down. The device consists of a rigid brace that attaches to the torso, legs and feet of the user via straps and supports. It is a bilateral robotic exoskeleton with four battery-powered motors that drive the knee and hip joints assisting in flexion-extension. The other degrees of freedom of the hip and knee joints are restricted. The ankle joint of the exoskeleton is passively articulated with a spring within a limited range of motion.

The exoskeleton is composed of a lumbar segment and two leg segments. The lumbar segment sits against the user's back and houses two rechargeable and swappable battery packs, the Electronic Central Unit (ECU), an inertial measurement unit (IMU), and Wi-Fi and Bluetooth modules. Each leg segment houses electrical actuators in the knee and hip, servo drives to control them, an electromagnetic safety brake at the knee, and an IMU sensor.

The device is controlled using either the Therapist Controller (up and down buttons located on the lumbar segment) or the Patient Controller (up and down buttons located on the Remote Controller, a wireless device that is mounted on the walker or crutches). These controllers allow the user to transition between the different states of the exoskeleton: (1) from the sitting position to the Transfer state, where the patient can put on the exoskeleton; (2) performing the sit-to-stand transition, where the device actively assists the knee and hip joints; (3) to standing, where the actuators apply the necessary torque to hold the user's legs straight and their trunk upright; (4) to walking, where the device moves the knee and hip joints following a natural gait pattern; (5) performing the stand-to-sit transition, where the device actively assists the knee and hip joints to sit down on a chair or medical bed.

The exoskeleton device is composed of the following components:

### Mechanical Frame

Frame: The structure of the exoskeleton is made out of carbon fibre and aerospace-grade aluminium, withstanding significant loads while keeping the device light and slim. This gives structural integrity to the device to hold all the device components and the patient in position.
Adjustments: Size adjustments to the exoskeleton are made through telescopic parts and pin locking mechanisms.
Rigid Supports: There are 4 rigid support pieces made of plastic on the upper thigh and upper shank that transfer the load and movement from the user to the exoskeleton frame, and vice-versa.
Modular upper-trunk part: A modular structural part that, if needed, attaches to the lumbar segment providing additional back postural support via shoulder straps for those users with higher injuries or limited trunk control.

### Ergonomic Fixtures

Leg straps: Textile straps attach the user to the support pieces and exoskeleton frame.
Foot straps: The feet are attached to the bottom footplate of the structure through plastic straps.
Padding: The lumbar segment, thigh and shank supports, lumbar belt, and all straps are covered with padding to protect the user from pressure injuries or discomfort.
Lumbar Belt: A textile belt is used to hold the user's trunk together with the exoskeleton frame.
Standup Belt: A textile belt is used to support the user during the sit-to-stand and stand-to-sit transitions.

### Joints

Actuators: There are 4 actuators on the exoskeleton, located in each of the hip and knee joints. The actuators apply force to move the legs of the exoskeleton to assist the patient in the motion of walking. The actuators are also used to facilitate the transfer of the patient to the exoskeleton, by positioning the device in a certain position (one leg lifted up vertical and straight, see Method section for more details) and locking the hip and knee joints.
Electromagnetic safety brake: The knee joints have an electromagnetic brake that activates when there is a power loss (to prevent the patient from falling to the ground) or when the leg is fully extended (to reduce power consumption).
Articulated Spring Ankle: The ankle joint can move in plantarflexion and dorsiflexion. This rotation is loaded with a spring, which is pulling the user back towards a “neutral” position.

### Electronics

Electronic Control Unit (ECU): The ECU is an electronic board located in the lumbar segment comprising the main system controller and all power management features.
Control Board: Electronic board located in the thigh leg segments of the exoskeleton comprising the servo drives to control the actuators.
Inertial Measurement Unit (IMU): The orientation and acceleration of each leg and the trunk are measured with 9 degree-of-freedom movement sensors (each sensor has a 3-axis gyroscope, a 3-axis accelerometer, and a 3-axis magnetometer).
Battery: The exoskeleton is powered by smart Lithium-Ion batteries.

### Method

To use the Yoga Leg, the following steps are performed with the device. In these steps, the word “user” denotes either the patient or the clinician, as both are considered users of the device. Some steps can be performed by either user.
1. the exoskeleton begins seated on a medical bed or in a chair. The device is powered by the clinician.
2. All straps and supports are opened by the user (clinician or patient). This allows having a greater open space inside the exoskeleton to perform the transfer of the patient into the device.
3. The user uses the device Controller (either the Therapist or the Patient Controller) to put the exoskeleton into the Transfer state.
4. The user moves the joints of the exoskeleton in the sagittal plane (hip flexion and knee extension) until the transfer position (Yoga Leg) is reached. In this position, one leg of the device (the user can decide if it's the right or the left leg) is lifted up vertical and straight (until the exoskeleton reaches the hip flexion mechanical limit, with the knee fully extended), while the other leg is with the foot on the ground in a sitting position (see FIG. 2B).
5. Once this position has been reached, the exoskeleton automatically detects that the position has been achieved and locks all the exoskeleton joints. The device provides auditory feedback to let the user know that the target transfer position has been reached and that the joints are locked. None of the joints can move, which provides a stable structure. The user does not need to touch or hold the device in any way.
6. Now that the exoskeleton is in the transfer position, the patient can enter the exoskeleton (move his body inside the device). The patient positions their wheelchair close to the bed/chair and exoskeleton, and transfers onto the bed/chair, moving his body under the leg of the exoskeleton, so they end up sitting between the hips of the exoskeleton with their feet flat on the floor. This type of transfer from a wheelchair to a bed is a standard skill that patients practice in regular clinical rehabilitation.
7. The user uses the device Controller (either of both) to leave the Transfer state, which unlocks the joints of the device so they can move again. This unlocking is done progressively and also with auditory feedback to let the user know that the joints are unlocked. The user brings the Yoga Leg down until the foot is flat on the floor.
8. The exoskeleton is now in a seated position, in the Sitting state. The straps of the device can be put on, and the session of exoskeleton training proceeds.
9. To transfer out of the exoskeleton at the end of the session, these steps are repeated. The only change is that the patient begins inside the device, and step 6 is a movement from inside the device back into the wheelchair.

This system allows the patient user to put on and take off the exoskeleton in a fast and easy way. Patients can perform this type of transfer independently even with severe motor limitations, allowing for a better user experience for the patient. This type of independence means that patients may prefer this method compared to the methods used by similar exoskeleton devices. Clinicians may also prefer that they can use this transfer time to set up other areas of the training facility or prepare for the therapy session, as the patient does not require significant assistance.

Additionally, it does not require additional mechanical complexity in the hip joint of the exoskeleton (no addition of moving parts, mechanisms, and joints to achieve new degrees of freedom such as abduction), as it utilises the joint movement in the sagittal plane that is already there to perform walking movements (hip flexion and extension). In terms of mechanical design, the only requirement for the exoskeleton to be able to perform this feature is having enough range of motion on the hip joints to lift a leg up vertical and straight, while having the other leg in a sitting position on a chair or bed (see FIG. 3B). Because no new mechanical parts or mechanisms are added to the device specifically for the transfer task, this method is considered desirable by the engineers developing the device. It also allows the device to be less expensive to design and produce, leading to overall cost savings for the customer (clinical institutions who buy the device, or patients who buy a device for personal use).

All of the above are fully within the scope of the present disclosure, and are considered to form the basis for alternative embodiments in which one or more combinations of the above described features are applied, without limitation to the specific combination disclosed above.

In light of this, there will be many alternatives which implement the teaching of the present disclosure. It is expected that one skilled in the art will be able to modify and adapt the above disclosure to suit its own circumstances and requirements within the scope of the present disclosure, while retaining some or all technical effects of the same, either disclosed or derivable from the above, in light of his common general knowledge in this art. All such equivalents, modifications or adaptations fall within the scope of the present disclosure.

1. A system to assist walking, comprising two orthoses, wherein the two orthosis comprise a first articulation for the hip articulation of each of the user's leg and a thigh segment, connected to the first articulation, wherein at least one orthosis further comprises:
a first fixing mechanism configured to fix the first articulation,
where in the at least one orthosis is configured to be set into a user transfer position, wherein in the user transfer position the first fixing mechanism is configured to fix the thigh segment at an angle of at least 60° with respect to the thigh segment of the opposite orthosis.

2. The system to assist walking according to claim 1, wherein the at least one orthosis further comprises:
a second articulation for the knee articulation of the user's leg, and
a second fixing mechanism configured to fix the second articulation,
wherein in the user transfer position, the second fixing mechanism is configured to fix the second articulation at a flexion angle of at most 45°.

3. A system to assist walking, comprising at least one orthosis for a user's leg, wherein said orthosis comprises:
a first articulation for the hip articulation of the user's leg,
a thigh segment connected to the first articulation,
a first fixing mechanism configured to fix the first articulation,
a first sensor configured to determine the position of the thigh segment, and
a control unit configured to control the first fixing mechanism,
wherein the control unit is configured to set the system into a user transfer state, wherein, in the user transfer state, the first fixing mechanism is configured to fix the first articulation into a user transfer position when the angle of thigh segment as determined by the first sensor is at most 30° with the vertical component.

4. The system according to claim 3, wherein said orthosis further comprises:
a second articulation for the knee articulation of the user's leg,
a shank segment connected to the thigh segment through the second articulation,
a second fixing mechanism configured to fix the second articulation, and
a second sensor configured to determine the position of the shank segment
wherein the control unit is further configured to control the second fixing mechanism, and
wherein in the user transfer state, the second fixing mechanism is configured to fix the second articulation into a user transfer position when the flexion angle of the shank segment as determined by the second sensor is at most 45°.

5. The system according to claim 3, wherein in the user transfer state, the first fixing mechanism is configured to fix the first articulation into a user transfer position when the angle of thigh segment as determined by the first sensor is at most 5° of the vertical component.

6. The system according to claim 3, wherein said orthosis further comprises:
a first actuator coupled to the first articulation and configured for setting the angle of flexion of the first articulation, wherein the control unit is further configured to control the angle of flexion of the first articulation through the first actuator; and/or
a second actuator coupled to the second articulation and configured for setting the angle of flexion of the second articulation, wherein the control unit is further configured to control the angle of flexion of the second articulation through the second actuator.

7. The system according to claim 6, wherein the orthosis comprises both the first actuator and the second actuator

8. The system according to claim 6, wherein the control unit is further configured to set the system into a sit position, wherein, in the sit position, the angle of flexion of the first articulation is set to the angle of flexion wherein the angle of thigh segment as determined by the first sensor is between 70° and 110° with the vertical component, and the angle of flexion of the second articulation is set to the angle of flexion wherein the angle of shank segment as determined by the second sensor is at between 135° and 200° with the vertical component, and
wherein the control unit is only configured to set the system into a user transfer state when the system is previously in a sit position.

9. The system according to claim 6, wherein in the user transfer state, the angle of flexion of the first articulation and the angle of flexion of the second articulation are set by the first and second actuators into a user transfer position to an angle at most 30° with the vertical component as an assistance to a user's movement of the first and second articulations, respectively.

10. The system according to claim 3, wherein in the user transfer state, the control unit is further configured to fix the articulations of the opposite orthosis.

11. The system according to claim 3, wherein the system further comprises a controller connected to the control unit and configured to allow the user and/or a therapist to instruct the control unit to set the system into the user transfer state and/or the user transfer position.

12. A method for moving into and out from a system to assist walking, wherein the system to assist walking is a system to assist walking according to claim 1, the method comprising:
instructing a control unit to set the system to assist walking into a user transfer state,
setting the first and second articulations into the user transfer position once a certain angle of the first and second articulation is reached by fixing the first articulation and/or the second articulation through the first fixing mechanism and the second fixing mechanism, respectively; and
moving the user into or out from the system to assist walking through the side of the at least one orthosis the system has set into the user transfer state.

13. The method according to claim 12, wherein the method comprises instructing the control unit to set the system to assist walking into a sit state prior to instructing the control unit to set the system to assist walking into the user transfer state.

14. The method according to claim 12, wherein the system to assist walking further comprises supports and/or straps, and wherein before instructing the control unit to set the system to assist walking into the user transfer state, the method comprises opening the supports and/or straps.

15. The method according to claim 12, wherein after instructing the control unit to set the system to assist walking into the user transfer state and before setting the first and second articulations into the user transfer position, the method comprises moving the first and/or second articulations to their user transfer position through the assistance of first and second actuators.

16. The method according to claim 12, wherein setting the first and second articulations into the user transfer position is performed automatically by the control unit once it detects the angles of flexion of the first and/or second articulations have reached their respective user transfer position.

17. The method according to claim 16, wherein the method further comprises providing feedback to the user once setting the first and second articulations into the user transfer position is performed.

18. The method according to claim 12, wherein setting the first and second articulations into the user transfer position further comprises fixing the articulations of the opposite orthosis into place.

19. The method according to claim 12, wherein the method further comprises:
instructing the control unit to set the system to assist walking out from the user transfer state.

20. The method according to claim 19, wherein setting the system to assist walking out from the user transfer state of comprises unlocking the first and second articulations from the user transfer position by unfixing the first fixing mechanism and the second fixing mechanism.

21. (canceled)

22. (canceled)
